(19) United States
(12) Patent Application Publication
(10) Pub. No.: US 2010/0052363 A1
(43) Pub. Date: Mar. 4, 2010

(54) Energy Absorbing Structures

(76) Inventor: Ian Antony Finney, West Midlands (GB)

Correspondence Address: NIXON & VANDERHYE, PC, 901 NORTH GLEBE ROAD, 11TH FLOOR, ARLINGTON, VA, 22203, US

(21) Appl. No.: 12/516,898

(22) PCT Filed: Nov. 27, 2007
(86) PCT No.: PCT/GB2007/004513

§ 371 Date: May 29, 2009

(30) Foreign Application Priority Data
Nov. 29, 2006 (GB) 0623797.8

(51) Int. Cl. B60R 21/00

(52) U.S. Cl. 296/187.03

(57) ABSTRACT

An energy absorbing structure comprises a body of material such as a foamed polyurethane or polystyrene. The body is covered by a cover. The body is relatively brittle, as compared with the cover member. An impact from a body results in cracks appearing preferentially in the body, rather than in the cover member. The cracks propagate through the body to absorb energy from the impact.

The present invention relates to energy absorbing structures, in particular, but not exclusively, for use in vehicle construction for protection from the effects of collisions.

The invention provides an energy absorbing structure comprising:

a body of a first material; and

a cover member of a second material, covering at least part of the surface of the body;

wherein the first material is brittle relative to the second material, to cause the first material to crack preferentially to the second material when the structure is subjected to an impact, and wherein, in use, the presence of the cover member results in cracks propagating preferentially through the body.

The cover member may cover at least part of an outer surface which is exposed during use.

The body may be an elongate member, substantially covered over the circumferential surfaces thereof. The body may be substantially wholly covered by the cover member. There may be one or more reinforcement members within the body.

Alternatively, the body may be mounted, in use, against a backing member which is less brittle than the body, to cause cracks to propagate preferentially through the body, between the cover member and the backing member.

The body may be a synthetic plastics material, such as a foamed material, such as polyurethane or polystyrene. The cover member may be a synthetic plastics material or a metal.

The structure may be mounted, in use, on a vehicle. The structure may form, in use, an exterior panel of the vehicle. The structure may form, in use, an impact absorbing barrier for protection of an adjacent component of the vehicle. The cover member may provide at least part of the outer surface of the vehicle.

In another aspect, the invention provides a vehicle panel comprising a structure as set out in any of the preceding six paragraphs.

In a further aspect, the invention provides a vehicle, comprising a structure as set out in the definitions above.

Examples of the present invention will now be described in more detail, by way of example only, and with reference to the accompanying drawings, in which:

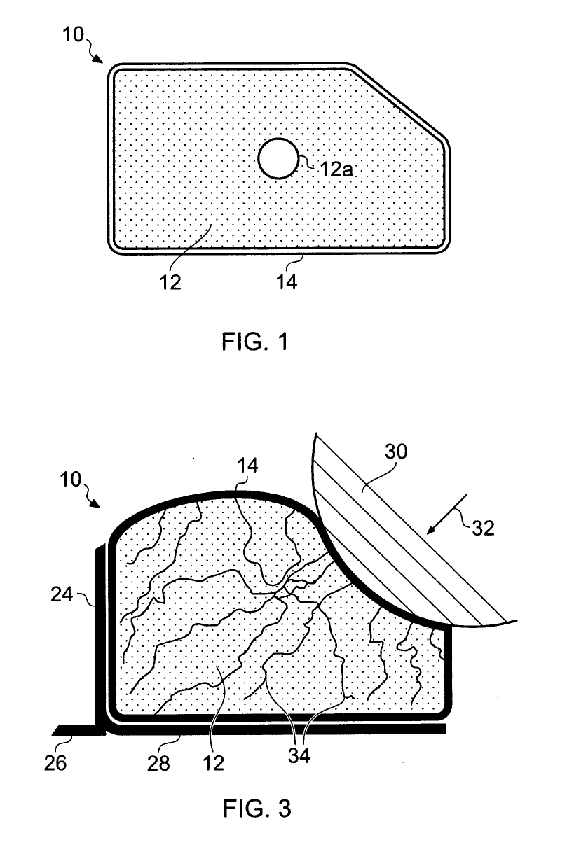

FIG. 1 is a section through an energy absorbing structure which is an example embodiment of the invention;

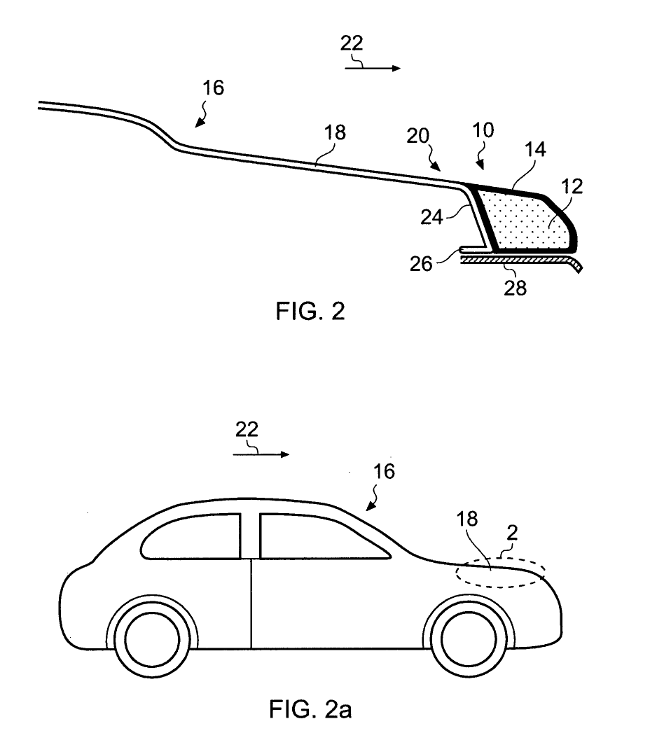

FIG. 2 is a partial section through a vehicle incorporating the structure of FIG. 1, the region of the section being schematically indicated as the region 2 in FIG. 2a;

FIG. 3 illustrates the structure of FIG. 1 in use and under impact;

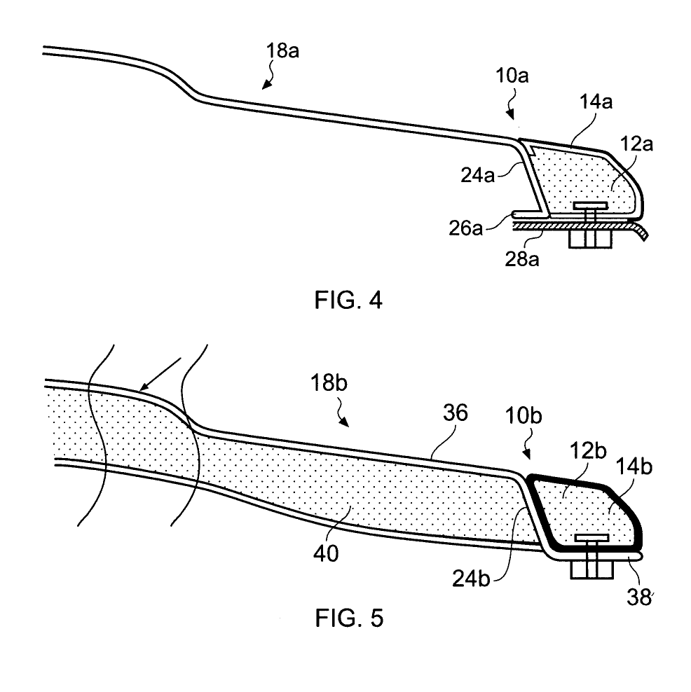

FIG. 4 corresponds with FIG. 2, showing an alternative energy absorbing structure;

FIG. 5 generally corresponds with FIGS. 2 and 4, illustrating the structure of FIG. 1 incorporated within an exterior panel of a vehicle;

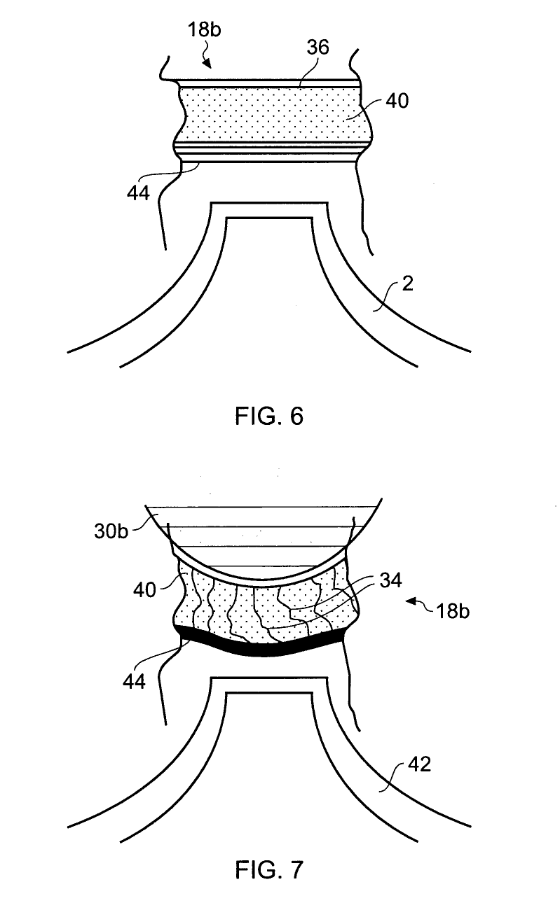

FIG. 6 shows part of FIG. 5 on an enlarged scale, together with additional vehicle components; and

FIG. 7 corresponds with FIG. 6, showing the structure under impact.

FIG. 1 illustrates an energy absorbing structure 10, comprising a body 12 of a first material. In this example, the first material is a synthetic plastics material such as polyurethane or polystyrene, which may be in a foamed form, forming a low density foam core for the structure 10. A cover member 14 covers at least part of the surface of the body 12. In this example, the body 12 is an elongate member of substantially constant cross-section (shown in FIG. 1) and the cover member 14 extends around the whole circumference of the body 12. The ends of the body 12 may also be covered by the cover member 14, or left exposed. Thus, the body 12 is substantially wholly covered by the cover member 14, including those parts of the outer surface of the body 12 which will be exposed during use, as will be described.

The cover member 14 may be a sheet of synthetic plastics material, such as polyurethane. The first material (of the body 12) is chosen to be brittle relative to the second material (of the cover 14). The significance of this will become apparent when considering FIG. 3.

The structure 10 is positioned for use in the manner illustrated in FIG. 2, which shows the region 2 of FIG. 2a on an enlarged scale. FIG. 2a is a section along the fore and aft axis of a vehicle 16. This has a bonnet panel 18 with a leading edge at 20. The structure 10 is positioned immediately in front of the leading edge 20 (in the direction of normal travel of the vehicle 16, indicated by arrow 22). However, the structure 10 could be used elsewhere, for example in the region of a vehicle bumper.

The leading edge 20 may be formed with a downwardly extending flange 24 finishing at a returning edge 26. The cover member 14 is secured to the flange 24, thereby supporting the structure 10 to the panel 18. A slam panel 28 may also be provided, attached to the edge 26 and extending underneath the structure 10, to provide protection for the structure 10 when the bonnet panel 18 is raised or lowered to open the bonnet for access to the engine or for other purposes.

Accordingly, in addition to the presence of the cover member 14, the rear and bottom surfaces of the body 12 are further backed by rigid sheet material provided by the flange 24 and the slam panel 28.

FIG. 3 illustrates the structure 10 during impact from a body 30, hitting the structure 10 from the direction indicated by the arrow 32. Comparison of FIG. 3 with FIG. 1 reveals various results of the impact. The cover member 14 has flexed inwardly in the region of the impact and has bulged outwardly in other regions, but has not ruptured. However, cracks 34 have formed within the body 12.

The relatively brittle nature of the material of the body 12, as compared with the material of the cover member 14, has resulted in cracks appearing preferentially in the body 12, rather than in the cover member 14. The cracks 34 propagate through the body 12 and represent breakages in the mechanical structure of the material of the body 12. Thus, as a crack propagates, energy is absorbed by the process of cracking the body 12. The absorbed energy is energy from the impact of the impact body 30.

Eventually, as cracking continues, cracks will reach the cover member 14 at positions remote from the impact body 30. Cracks cannot then propagate further through the body 12, except by changing direction, in a manner similar to reflecting off the cover member 14.

Consequently, as more energy is absorbed from the impact, cracks can propagate in many directions and repeatedly, through the body 12, until a significant amount of the impact energy has been absorbed by the body 12.

The result is expected to be a high degree of energy absorption within the body 12. In particular, cracks can propagate through the body 12, distributing energy away from the impact position, and absorbing the energy. Thus, a larger volume of the body 12 can be involved in the process of absorbing energy than would be the case for resilient response, for example. Eventually, the structure 10 will be saturated by absorbed energy, and fail, possibly by the cover member 14 rupturing. If that point is reached, a very large amount of energy will have been absorbed, but further impact energy would be absorbed by the bonnet panel 18. However, it is expected that by appropriate design of the structure 10, and choice of materials, a wide range of impact energies can be absorbed before failure of the structure 10.

Returning to FIG. 1, a reinforcement 12a is visible, which may be rigid or semi-rigid, a bar, tube or other form, and of metal, composite or other material. The reinforcement 12a may be omitted in some examples. The reinforcement will tend to support the structure against premature collapse, thereby affecting the dynamics of performance of the structure 10, during impact.

FIG. 4 illustrates a variation on the arrangements described above. In this example, a structure 10a has a body 12a partially covered by a cover member 14a. Materials for the body 12a and cover member 14a may be as described above in relation to FIG. 1. In this example, the cover member 14a leaves the rear face of the body 12a uncovered, but the structure 10a is installed against the flange 24a of the leading edge 20a of the bonnet panel 18a. Accordingly, that face of the body 12 which is not covered by the cover member 14 is nevertheless against a surface which is less brittle than the body 12 and accordingly, cracks can propagate to the flange 24a and reflect from it, in the manner described above in relation to FIG. 3.

FIG. 5 illustrates a further variation. In this example, a first structure 10b is formed along the front edge of a bonnet panel 18b. The structure 10b is equivalent to the structure 10 of FIG. 1, having a body 12b and cover member 14b. The outer surface 36 of the bonnet panel 18b turns down to form a flange 24b and then turns forward, rather than returning, to form a forward flange 38. The structure 10b sits on the forward flange 38, against the flange 24. In the event of an impact to the structure 10b, initial response is in the same manner as described above in relation to FIG. 3, namely that energy is absorbed within the body 12, by a process of cracking.

The outer surface 36 of the bonnet panel 18b is backed by a further body 40 of the same material as the body 12, so that the outer surface 36 and further body 40 form a further example of an energy absorbing structure 10b, which is an example embodiment of the invention.

Away from the edge 26b, the bonnet panel 18b may be in close proximity to relatively dangerous structures such as hard parts of an engine 42 (such as the cylinder block), illustrated highly schematically in FIG. 6.

The material of the further body 40 may be protected, on the face facing the engine 42, by a barrier layer 44 protecting against heat, water or oil reaching the further body 40.

In the event of an impact by an impact body 30b (FIG. 7) on the outer surface of the bonnet panel 18b, in the region of the engine 42, the outer surface 36 will deflect, transferring energy to the further body 40, which will crack as illustrated in FIG. 7 in the manner described above, thereby distributing impact energy through a large volume of the further body 40, and absorbing the energy. Accordingly, it is envisaged that by distributing the impact energy away from the point of impact, the risk is reduced of the impact body 30b deforming the panel 18b sufficiently to impact on the engine 42.

Many variations and modifications can be made to the apparatus described above, without departing from the scope of the present invention. In particular, many alternative shapes and forms for structures could be envisaged, and a wide variety of alternative materials could be used for the body 12 and cover member 14, while retaining important functions of those features, namely (for the body) to crack under impact, thereby distributing and absorbing energy and (for the cover) to deform to convey energy to the body 12, but to avoid rupturing, at least initially, and to encourage cracks to reflect back into the body 12, to propagate further, thereby absorbing further energy.

Energy absorbing structures, of the type described, can be used outside the vehicle or within the passenger compartment, in either case to reduce the risk of injury in the case of collision.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. An energy absorbing structure comprising:
a body of a first material; and
a cover member of a second material, covering at least part of the surface of the body;
wherein the first material is brittle relative to the second material, to cause the first material to crack preferentially to the second material when the structure is subjected to an impact, and wherein, in use, the presence of the cover member results in cracks propagating preferentially through the body.

2. A structure according to claim 1, wherein the cover member covers at least part of an outer surface which is exposed during use.

3. A structure according to claim 1, wherein the body is an elongate member, substantially covered over the circumferential surfaces thereof.

4. A structure according to claim 1, wherein the body is substantially wholly covered by the cover member.

5. A structure according to claim 1, wherein the body is mounted, in use, against a backing member which is less brittle than the body, to cause cracks to propagate preferentially through the body, between the cover member and the backing member.

6. A structure according to claim 1, comprising one or more reinforcement members within the body.

7. A structure according to claim 1, wherein the body is a synthetic plastics material.

8. A structure according to claim 7, wherein the synthetic plastics material is a foamed material.

9. A structure according to claim 7, wherein the synthetic plastics material is polyurethane or polystyrene.

10. A structure according to claim 1, wherein the cover member is a synthetic plastics material or a metal.

11. A structure according to claim 1, mounted, in use, on a vehicle.

12. A structure according to claim 11, forming, in use, an exterior panel of the vehicle.

13. A structure according to claim 11, forming, in use, an impact absorbing barrier for protection of an adjacent component of the vehicle.

14. A structure according to claim 11, wherein the cover member provides at least part of the outer surface of the vehicle.

15. A vehicle panel comprising a structure as set out in claim 1.

16. A vehicle, comprising a structure as set out in claim 1.

17-18. (canceled)
